(19) United States
(12) Patent Application Publication
(10) Pub. No.: US 2022/0322500 A1
(43) Pub. Date: Oct. 6, 2022

(54) COMPACT INDUCTION HEATING SYSTEM WITH MOVABLE COIL

(71) Applicant: Siemens Energy Global GmbH & Co. KG, Munich, Bayern (DE)

(72) Inventors: Matthias Goldammer, Munchen (DE); Hubert Mooshofer, München (DE)

(73) Assignee: Siemens Energy Global GmbH & Co. KG, Munich, Bayern (DE)

(21) Appl. No.: 17/640,541

(22) PCT Filed: Sep. 3, 2020
(86) PCT No.: PCT/EP2020/074570

§ 371 Date: Mar. 4, 2022

(30) Foreign Application Priority Data
Sep. 18, 2019 (EP) 19198115.8

(51) Int. Cl. H05B 6/10; H05B 6/40; H05B 6/04; H05B 6/42; H01B 7/42; B33Y 30/00; B22F 12/00

(52) U.S. Cl. CPC H05B 6/101; H05B 6/40; H05B 6/04; H05B 6/42; H01B 7/423; B33Y 30/00; B22F 12/00

(57) ABSTRACT

An induction heating system for heating a component, the induction heating system having an alternating voltage supply device, a capacitor, a displacement unit, and an induction coil. The alternating voltage supply device supplies alternating voltage to a series resonant circuit which is formed by the capacitor and the induction coil. The displacement unit allows the induction coil to be displaced laterally in at least one direction relative to the component. The capacitor is situated between the displacement unit and the induction coil. A device for the additive manufacturing of a component uses such an induction heating system.

### CROSS REFERENCE TO RELATED APPLICATIONS

This application is the US National Stage of International Application No. PCT/EP2020/074570 filed 3 Sep. 2020, and claims the benefit thereof. The International Application claims the benefit of European Application No. EP19198115 filed 18 Sep. 2019. All of the applications are incorporated by reference herein in their entirety.

### FIELD OF INVENTION

The invention relates to an induction heating system for heating a component as well as to a device for additive manufacturing of a component with an induction heating system of this type.

### BACKGROUND OF INVENTION

Inductive heating is a method for heating electrically conductive bodies through eddy current losses generated in them. For this purpose, an induction heating system uses a coil which has alternating current flowing through it and which is also referred to as an induction coil or inductor. The coil generates an alternating magnetic field which induces eddy currents in the material. Inductive heating is used, for example, when annealing, soldering, welding, melting, shrinking or during material testing.

It was not so long ago that the idea emerged to also use inductive heating in additive manufacturing of a component. For this purpose, a powder or wire metallic material, which is applied to a platform in layers, is preheated before melting, for example. Alternatively, the melted material can also be inductively heated after melting. In both cases, with suitable process parameters, the material quality of the additively manufactured component can be expected to improve.

The heating power of the inductor generally only acts in a small region, usually within a few centimeters, around the coil. However, in the case of additive manufacturing of a component, for example by means of selective laser melting, a comparatively large surface is to be heated. Consequently, a displaceable (in other words: traversable) primary heating device, for example a laser beam source, is fitted with the induction coil, such that it is also displaceable relative to the component. The rest of the induction heating system can be used as before.

An induction heating system is known to have a series resonant circuit which is formed by a capacitor and the induction coil and is supplied with alternating voltage by an alternating voltage supply device. In order to achieve a high heating power of the induction heating system, a high current is usually specified in the resonant circuit. This is achieved, for example, using an induction generator which generates high voltages up to several kilovolts and a transformer which transforms this high input alternating voltage into a low output alternating voltage but a high current. A low voltage is effectively applied in the series resonant circuit, but there exists a high reactive alternating voltage.

Consequently, one challenge is the fact that at the electrical lines of the induction heating system, both a high voltage is applied and high currents flow through. The high currents mainly cause heat which must be dissipated. The high voltage poses a risk that a voltage flashover may occur which may lead to a system failure or, in the worst case, to the operator of the system being in danger.

This creates the problem that the supply lines of the traversable coil must be protected both against overheating and against voltage flashovers.

Against overheating of the lines, cooling, for example with water, is known. However, water-cooled electrical cables are generally not suitable for frequent bending, like that which occurs in an induction heating system with a moving coil. Water-cooled copper rails are therefore used, for example. In this case, the displaceability of the induction coil may be realized with a slide which is displaceable on the rail and is electrically connected to the rail by means of a sliding contact. Water-cooled copper rails and sliding contacts have the ability to conduct current in the range of several 100 A, however a high voltage of several 100 V is also applied. The voltage safety must therefore also be ensured in addition to the current-carrying capacity. While regulation of the induction generator has the ability to respond to changes in inductance or line resistance, flashovers can result in system failure. The operational safety of this solution is therefore low and may result in failure. As a countermeasure, the maximum power must be limited.

### SUMMARY OF INVENTION

The object is therefore to provide an improved induction heating system in comparison to the prior art with a displaceable induction coil as well as an improved device in comparison to the prior art for additive manufacturing of a component with an induction heating system of this type.

These objects are achieved by the subject-matters of the independent claims. Advantageous embodiments are specified in the dependent claims.

The invention comprises an induction heating system for heating a component, wherein the induction heating system has an alternating voltage supply device, a capacitor, a displacement unit and an induction coil. The alternating voltage supply device supplies alternating voltage to a series resonant circuit which is formed by the capacitor and the induction coil. The displacement unit enables the induction coil to be displaced laterally in at least one direction relative to the component. The capacitor is arranged between the displacement unit and the induction coil.

The underlying idea of the invention is to place the capacitor as close as possible to the induction coil in order to locally limit the series resonant circuit in which the high reactive voltages are present. Since the reactive voltages are only present in those electrical lines (also referred to as “supply lines” in the context of this application) which run between the capacitor and the coil, only these lines or only these corresponding areas are exposed to the danger of voltage flashovers. By placing the capacitor “behind” the displacement unit (from the perspective of a current direction which runs from the alternating voltage supply device to the induction coil), in particular the region at the displacement unit, which is conventionally particularly susceptible to voltage flashovers, is no longer exposed to the comparatively high reactive voltage, but rather only to the comparatively low alternating voltage effectively applied.

In one advantageous embodiment of the invention, the alternating voltage supply device comprises an induction generator for generating an input alternating voltage and a transformer for converting the input alternating voltage into an output alternating voltage.

The induction generator generates an alternating voltage with a frequency between a few kilohertz and several megahertz as well as a voltage up to 2,000 volts, for example. This voltage can be conducted to a transformer by means of a cable, which transformer transforms this high voltage as an input alternating voltage into a lower output alternating voltage. However, a relatively low input current strength is consequently transformed into a high output current strength which is available to the induction coil.

The displacement unit is able to displace (in other words: to transverse or to move) the induction coil at least in one direction sideways (in other words: laterally). In this case, the lateral displacement refers to a lateral displacement with respect to the component. In particular, it therefore does not mean a displacement perpendicular to the surface of the component, i.e. toward it or away from it. This displacement is necessary because the purpose of the induction heating system is to heat the component but an induction coil can only ever heat a small region around the conductor of the coil. Assuming a component whose planar expansion is large compared to the induction coil and which is to be heated at least successively in a plurality of or even all regions, the induction coil must move relative to the component.

In particular, in one embodiment of the invention, the displacement unit is realized by at least one rail and at least one slide. In this case, the slide is designed to move on the rail. The rail thus specifies the direction along which the slide, and therefore also the induction coil, can move.

In practice, the displacement unit can also have two rails arranged in parallel, i.e. a so called pair of rails, wherein the slide is then displaceable on the pair of rails.

The displacement unit is advantageously configured in such a way that it enables movability of the induction coil in more than one direction, in particular in two directions which are perpendicular to one another. In this case, those directions which enable a displacement of the induction coil laterally to the component are particularly relevant. The displacement unit is advantageously configured in such a way that the induction coil is displaceable over the entire surface of the component in plan view. As a result, the entire surface of the component opposite the induction coil can thus be heated.

The electrical contact between the rail and the slide of the displacement unit can be realized by means of a sliding contact, for example.

In the present induction heating system, the rail can be designed as a (water-cooled) copper rail, for example, and the slide can have a current collector which travels along the copper rail. Some material abrasion to rails and/or current collectors is likely over time, which increases the likelihood of charge flashovers. However, since the voltage at the sliding contacts can be selected to be low through the configuration of the induction heating system according to the invention, the likelihood of charge flashovers can be significantly reduced.

The specific placement of the capacitor depends on each individual case. One possibility is to place the capacitor so close to the induction coil that the capacitor and induction coil form a so called induction module and this is also structurally identified, for example by a common housing. The common housing is in itself advantageous because the electrical lines between the capacitor and induction coil are very touch sensitive as a result of the high reactive voltages.

The capacitor is generally relatively voluminous, in order to be able to receive the high voltages which are induced by the induction coil. It can therefore be attractive or necessary to provide a further capacitor which is located between the alternating voltage supply device and the displacement unit and which, together with the capacitor between the displacement unit and induction coil, forms the capacitive resistance of the series resonant circuit. The voltage can be adjusted in an application-specific manner via the displacement unit by dividing the total capacitance before and after the displacement unit and therefore any compromise can be reached between size and flashover safety.

The induction heating system according to the invention can particularly advantageously be used in additive manufacturing of a component. One further aspect of the invention is therefore a device for additive manufacturing of a component which has the following elements: a platform which is provided in order to apply a powder or wire metallic material thereon in layers; a primary heating device which is designed to melt a powder or wire metallic material applied to the platform; and an induction heating system. In this case, the induction coil of the induction heating system is traversable above the platform and is designed to heat the powder or wire metallic material applied to the platform.

A laser beam source or an electron beam source are considered to be a primary heating device, for example. In this case, an advantageous embodiment involves arranging a laser beam or electron beam of the laser beam source or electron beam source in such a way that it can pass through a window (or: opening) which defines the induction coil and can thus heat the powder or wire metallic material applied to the platform. The window of the induction coil can also be referred to as a coil interior.

The invention is illustrated hereinafter using the accompanying figures. The figures show embodiments selected in an exemplary and schematic manner without limiting the claimed scope of protection.

### BRIEF DESCRIPTION OF THE DRAWINGS

In the figures:

FIG. 1: shows a device for additive manufacturing of a component with an induction heating system according to the invention;

FIG. 2: shows an electrical circuit diagram of the induction heating system from FIG. 1; and

FIG. 3: shows an electrical circuit diagram of a conventional induction heating system.

### DETAILED DESCRIPTION OF INVENTION

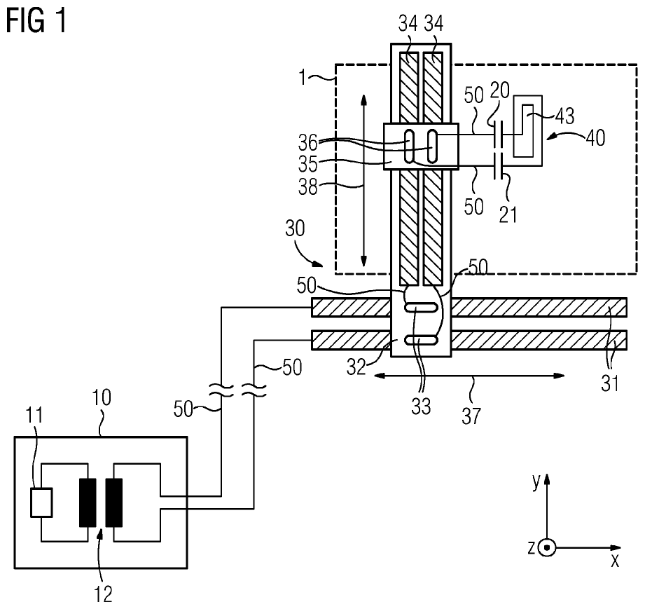

FIG. 1 (also referred to as FIG. 1) shows a device for additive manufacturing of a component 1 with an induction heating system according to the invention. The device comprises a platform which is provided in order to apply a powder or wire metallic material thereon in layers as well as a primary heating device which is designed to melt a powder or wire metallic material applied to the platform. These parts of the device are standard parts of a system for additive component manufacturing (also: additive manufacturing or 3D printing) and are not shown in FIG. 1 for the sake of clarity. Their configuration and connection relative to one another are well known to the person skilled in the art within the field of additive manufacturing, in particular selective laser melting.

The device further has an induction heating system for heating the material. Both preheating of the material which has not been melted yet and post-treatment of the material which has already been melted are possible with the induction heating system. In principle, inductive heating of the metallic material is also possible during melting by means of a laser beam source or electron beam source, for example.

The induction heating system has an alternating voltage supply device 10 which consists of an induction generator 11 and a transformer 12. The induction generator 11 generates alternating voltage with an effective voltage of several hundred volts up to several kilovolts. In this case, the current strength is moderate and is between 10 A and 100 A, for example. In order to achieve a high heating power through the induction coil, said coil must have a high current strength, which in particular is higher than 100 A, flowing through it. A transformer 12 is therefore connected to the induction generator 11. The transformer 12 converts the high voltage of the induction generator 11 into a lower voltage, which directly results in an increase in the current strength in the circuit at the output of the transformer 12. The circuit at the input of the transformer 12 is also referred to as a “generator circuit”; the circuit at the output of the transformer 12 as a “working circuit”.

The alternating voltage supply device 10 is connected to a displacement unit 30 by means of electrical lines, which are also referred to as supply lines 50 in the context of this application. The purpose of the displacement unit 30 is to make the induction coil 40 connected to it displaceable with respect to a stationary component 1. For this purpose, a first slide 32 and a second slide 35 can in each case be controlled by means of a control device. For the sake of clarity, the control device for the displacement unit 30 is not shown in FIG. 1 and it is also not explored in greater detail in this description, since it does not relate to the essence of this invention.

The first slide 32 is located on a first pair of rails 31 by means of two first sliding contacts 33. The sliding contacts 33 are made of an electrically highly conductive metal, for example, likewise the two rails of the first pair of rails 31. Copper can be specified as a suitable material for the sliding contacts 33 and the pair of rails 31, for example. The first sliding contacts 33 are for their part in turn connected to a second pair of rails 34 by means of electrical conductors 50. The second pair of rails 34 forms the bearing surface for the second slide 35, the second sliding contacts 36 of which are electrically connected to the rails of the second pair of rails 34. The second sliding contacts 36 are connected to the induction coil 40 by means of supply lines 50. The first slide 32 is moveable back and forth along a first displacement direction 37 (here corresponding to the x direction); the second slide 35 is moveable back and forth along a second displacement direction 38 (here corresponding to the y direction). For the induction coil 40, it follows that it is displaceable in a region (or: surface) defined by the displacement unit 30.

The induction coil 40 is not drawn to scale in FIG. 1 (as well as the alternating voltage supply device 10, for example) with respect to the other components. In most real cases, it will be significantly smaller. However, for the sake of clarity, it is drawn as a large, double-wound coil in FIG. 1. In this case, the induction coil defines a window 43 through its coil interior, through which window a laser beam can advantageously pass to the material which is to be treated.

One essential part of an induction heating system is a capacitor which, together with the induction coil, forms a series resonant circuit, also referred to as an RLC resonant circuit. Owing to the high currents which flow through the induction coil, the inductance of the coil is high and the capacitance of the capacitor must be selected to be correspondingly large. This results in a certain structural size and weight of the capacitor. As a result, in conventional induction heating systems, the capacitor(s) was (or were) built into the alternating voltage supply device, since the alternating voltage supply device with the induction generator and transformer already claimed a lot of space and also weight. The induction generator and transformer are also often surrounded by a common housing, so that the capacitor could also be accommodated and protected efficiently therein.

In the case of a stationary induction coil, i.e. an induction coil which is immovable relative to the alternating voltage supply device, well insulated, optionally water-cooled electrical cables can be used as electrical lines between the capacitor located at the alternating voltage supply device and the induction coil, for example, so that no voltage flashovers occur in the supply lines.

In the case of a moveable induction coil, i.e. an induction coil which is moveable relative to the alternating voltage supply device, water-cooled electrical cables may not be able to be used, since they are not suitable for frequently occurring movements. However, if contact rails and sliding contacts are used, this creates the problem of potential voltage flashovers, such that the maximum power in the resonant circuit must be limited, for example.

The idea of the present invention is not to place the capacitor 20 close to the alternating voltage supply device 10, as is conventional, but rather between the displacement unit 30 and the induction coil 40. One possible position is shown in FIG. 1 in a schematic manner.

FIG. 1 further shows a second capacitor which is referred to as an additional capacitor 21 hereinafter. It essentially serves as an additional capacitor in order to have more flexibility to set the capacitance of the resonant circuit.

It must be decided in each individual case whether sufficient space is available or can be provided in order to place the capacitor 20 and optionally the additional capacitor 21 between the displacement unit 30 and the induction coil 40. Should this be difficult, an attractive compromise, for reducing the risk of voltage flashovers, between, on the one hand, the structural constraints and, on the other hand, necessity can involve designing the capacitor 20 to be only just as large as possible and therefore placing a further capacitor close to the alternating voltage supply device 10, as is conventional. The total capacitance of the series resonant circuit is then formed from the capacitor 20 close to the induction coil and the further capacitor close to the alternating voltage supply device 10.

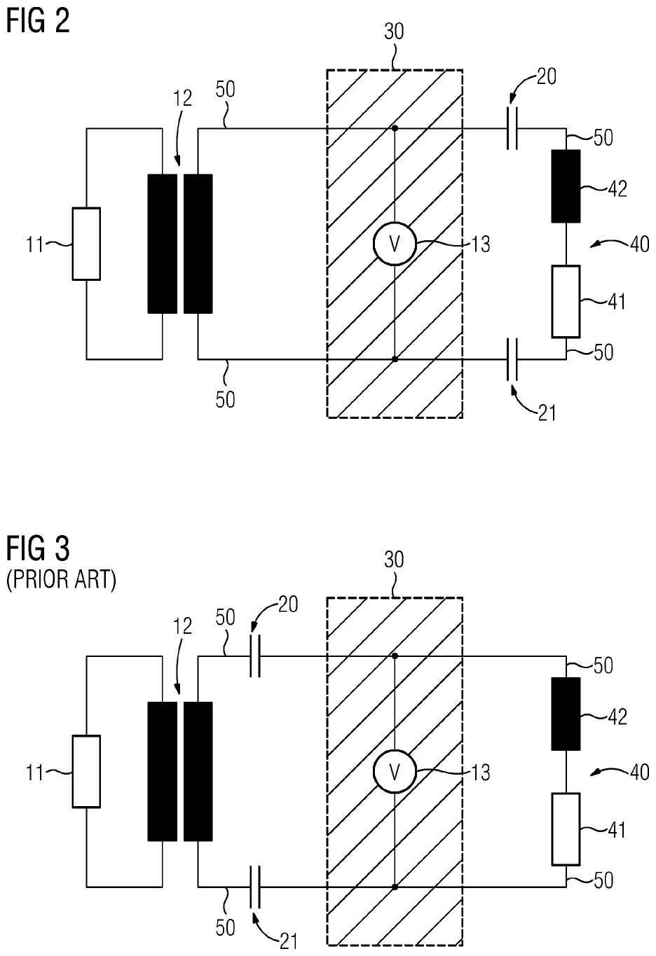

FIG. 2 (also referred to as FIG. 2) shows an electrical circuit diagram of the induction heating system from FIG. 1. The generator circuit is formed by the induction generator 11 and the one coil of the transformer 12. The working circuit is formed by the second coil of the transformer 12, the capacitor 20, the additional capacitor 21 and the induction coil 40. For the induction coil 40, both the ohmic resistance 41 and the inductive resistance 42 is marked in FIG. 2. The supply lines 50 also have an ohmic resistance and this is accompanied by ohmic losses (which for the most part are absorbed and dissipated by the water cooling of the supply lines 50). These ohmic losses are not marked in FIG. 2 because they do not constitute the essence of the invention. In FIG. 2, the displacement unit 30 is further symbolized by the shaded rectangle.

Owing to the placement of the capacitor 20 and the additional capacitor 21 between the displacement unit 30 and the induction coil 40, only the relatively low output alternating voltage of the transformer 12 is measured at a voltage measuring device 13 at the displacement unit 30—i.e. at the sliding contacts, for example, which are particularly susceptible to and critical for voltage flashovers. Bearing in mind the fact that in dry air, as a very rough rule of thumb, the likelihood of a voltage flashover is significantly increased for exposed contacts one millimeter apart from one another from approximately 1,000 volts, the risk of a voltage flashover in a structure as shown in FIG. 1 or FIG. 2 is negligible.

However, this does not apply to a structure as shown in FIG. 3 (also referred to as FIG. 3). FIG. 3 shows an electrical circuit diagram of a conventional induction heating system in which the capacitor 20 and the additional capacitor 21 are arranged “in front” of the displacement unit 30, i.e. between the alternating voltage supply device 10 and the displacement unit 30. All other components in FIG. 3 correspond to the components from FIG. 2, such that they are not repeated for reasons of scarcity.

As a result of the different placement of the capacitor 20 and the additional capacitor 21, in conventional systems, high voltages owing to the reactive voltage in the series resonant circuit are also measured in the supply lines 50 at the displacement unit 30, i.e. also at the sliding contacts 33, 36, for example. Since they are not virtual voltages but rather real applied voltages, they can also be detected by means of a voltage measuring device 13 which is placed on the displacement unit 30. In the case of correspondingly high inductance of the coil 41, capacitance of the capacitors 20, 21 and applied current strength, a reactive voltage can be generated which is in a range at which charge flashovers are likely.

In summary, owing to a skilled arrangement of its components, the present invention enables an induction heating system which, even in the case of a moveable induction coil, enables a high degree of operational safety without having to compromise on the maximum heating power.

1. An induction heating system for heating a component, the induction heating system comprising:
an alternating voltage supply device,
a capacitor,
a displacement unit, and
an induction coil,
wherein the alternating voltage supply device supplies alternating voltage to a series resonant circuit which is formed by the capacitor and the induction coil,
wherein the displacement unit enables the induction coil to be displaced laterally in at least one direction relative to the component, and
wherein the capacitor is arranged between the displacement unit and the induction coil.

2. The induction heating system as claimed in claim 1,
wherein the alternating voltage supply device has an induction generator for generating an input alternating voltage and a transformer for converting the input alternating voltage into an output alternating voltage.

3. The induction heating system as claimed in claim 1,
wherein the displacement unit has a rail and a slide,
wherein the slide is designed to move on the rail and wherein the rail defines the direction along which the induction coil moves.

4. The induction heating system as claimed in claim 3,
wherein an electrical contact between the rail and the slide is realized by a sliding contact.

5. The induction heating system as claimed in claim 1,
wherein the displacement unit enables the induction coil to be displaced laterally in two directions relative to the component.

6. The induction heating system as claimed in claim 5,
wherein the displacement unit enables the induction coil to be displaced over an entire surface of the component in plan view.

7. The induction heating system as claimed in claim 1,
wherein the induction coil and the capacitor form an induction module which is displaceable by the displacement unit and are surrounded by a common housing.

8. The induction heating system as claimed in claim 1,
wherein the series resonant circuit has, at least partially, liquid-cooled electrical lines.

9. The induction heating system as claimed in claim 1,
wherein the induction heating system has a further capacitor which is located between the alternating voltage supply device and the displacement unit and, together with the capacitor between the displacement unit and induction coil, forms the capacitive resistance of the series resonant circuit.

10. A device for additive manufacturing of a component, comprising:
a platform which is provided in order to apply a powder or wire metallic material thereon in layers,
a primary heating device which is adapted to melt a powder or wire metallic material applied to the platform, and
an induction heating system as claimed in claim 1,
wherein the induction coil is traversable above the platform and is designed to heat the powder or wire metallic material applied to the platform.

11. The device as claimed in claim 10,
wherein the primary heating device is designed as a laser beam source or an electron beam source, and
wherein the induction coil defines a window through which a laser beam or electron beam of the laser beam source or electron beam source can pass and can heat the powder or wire metallic material applied to the platform.

12. The device as claimed in claim 10,
wherein the primary heating device comprises a laser beam source or an electron beam source.

13. The induction heating system as claimed in claim 5,
wherein the displacement unit enables the induction coil to be displaced laterally in two directions relative to the component, wherein the two directions are perpendicular to one another.

14. The induction heating system as claimed in claim 8,
wherein the series resonant circuit has, largely, liquid-cooled electrical lines.
